(19) United States
(12) Patent Application Publication
(10) Pub. No.: US 2023/0278932 A1
(43) Pub. Date: Sep. 7, 2023

(54) FLASH SINTERING

(71) Applicant: Oxford University Innovation Limited, Oxford (oxfordshire) (GB)

(72) Inventors: Yinsheng LI, Oxford (GB); Simone FALCO, Oxford (GB); Riccardo TORCHIO, Padua (IT); Piergiorgio ALOTTO, Padua (IT); Richard TODD, Oxford (GB)

(21) Appl. No.: 17/686,601

(22) Filed: Mar. 4, 2022

(51) Int. Cl. C04B 35/64

(52) U.S. Cl. CPC C04B 35/64; C04B 2235/666

(57) ABSTRACT

A method of performing a flash sintering of a specimen (200, 300, 400, 600), the method comprising: connecting an anode electrode (102) to a specimen (200, 300, 400, 600) at an anode contact and connecting a cathode electrode (102) to the specimen (200, 300, 400, 600) at a cathode contact; flowing current through the specimen (200, 300, 400, 600) from the anode electrode (102) to the cathode electrode (102) to heat the specimen (200, 300, 400, 600) by Joule heating and thereby sinter it; wherein at least one of the anode contact and the cathode contact is configured to reduce a temperature gradient between a core (110, 610) in a central region of the specimen (200, 300, 400, 600) and a surface (120, 620) of the specimen (200, 300, 400, 600).

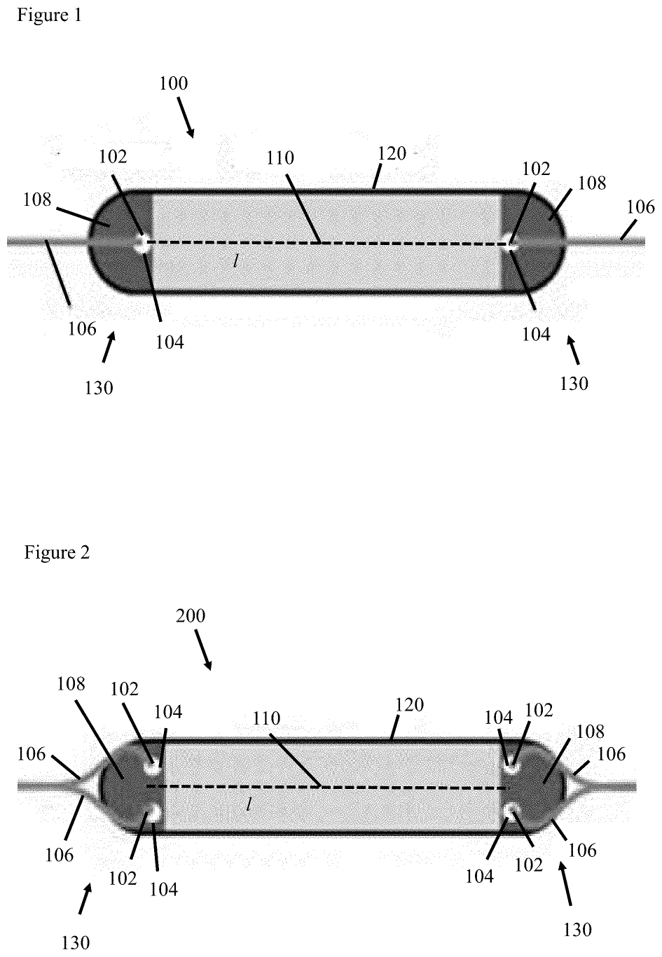

FIG. 2 is to be reproduced with the Abstract.

### TECHNICAL FIELD

The present invention relates to a method of flash sintering, a method of modelling a flash sintering process and a sintered material.

### BACKGROUND

Sintering is a process of heat-assisted (and possibly also pressure-assisted) compacting of particles to form a dense material. Sintering is used on base materials in powder form to create ceramic parts, which are used to make components in products such as smartphones, computers, televisions, automotive electronics, and medical devices, as well as being widely used in building.

Sintering simply performed in a furnace takes hours. Electric current can be used to drive or enhance sintering, as in well-known processes of electric current activated sintering (ECAS). Flash sintering (FS) is an example of ECAS; a newer process in which electric current is applied using electrodes to cause electrical Joule heating, leading to far more rapid densification of particles versus most earlier sintering techniques. FS typically has a discharge time of between 0.1 seconds and 1 minute.

A problem of FS is that it generates thermal gradients, which are closely related to the formation of preferential current paths inside the ceramic sample. Since the sample surface releases heat via thermal radiation during FS, the sample surface is typically cooler than the core region. The hotter region is generally more electrically conductive, resulting in increases of local current density and power dissipation. A significant thermal gradient may form between the core and the surface, which may in turn be detrimental to the densification and microstructure homogeneity of ceramics.

Ultrafast ECAS may provide a solution to the problem under some circumstances, as the capacitive discharge is so quick that energy losses are minimal. However, Ultrafast ECAS is not suitable for some materials or dimensions of specimens, for example, or FS may otherwise be preferred.

Conductive pastes have been used on the surface of the compact around the electrodes of bar-shaped specimens to spread out the current input, but this does not completely solve problems with temperature gradients.

One solution to the problem of temperature gradients is to insulate the outside of the specimen to prevent heat loss and reduce thermal gradients. This may be effective, but it does not completely remove the issues described above.

The present invention seeks to improve FS.

### SUMMARY

An aspect of the present invention provides a method of performing flash sintering of a specimen, the method comprising:
connecting an anode electrode to a specimen at an anode contact and connecting a cathode electrode to the specimen at a cathode contact;
flowing current through the specimen from the anode electrode to the cathode electrode to heat the specimen by Joule heating and thereby sinter it;
wherein at least one of the anode contact and the cathode contact is configured to reduce a temperature gradient between a core in a central region of the specimen and at least a portion of a perimeter surface of the specimen.

One or more of a position, number and shape of the cathode contact and/or anode contact may be configured to reduce the temperature gradient.

In general, moving the anode contact position and the cathode contact position away from a centre-line and closer to a surface of the specimen will improve uniformity of sintering, because heat is lost from the surface and moving the contact positions nearer to the surface will result in increased current density near the surface, tending to at least partially compensate for the heat loss at the surface.

The specimen may comprise a longitudinal direction generally in the direction of current flow through the specimen. The specimen may comprise a longitudinal axis on a centre of the sample and in the longitudinal direction. A lateral direction may be defined perpendicular to the longitudinal direction.

The reduction in temperature gradient may be relative to an anode contact position and a cathode position that are each positioned on a centre-line (or longitudinal axis) of the specimen.

The specimen may comprise a layer of material with an upper surface and lower surface that are parallel and offset by a thickness of the layer of material (or layer thickness). The specimen may be defined by the perimeter surface which extends between the upper surface and lower surface. The lateral direction may extend between opposite wall surfaces.

At least one of the anode contact position and the cathode contact position may be selected to reduce a temperature gradient between the core and at least a portion of the wall surface. The central region may include a centroid of a current carrying cross section of the specimen. The current carrying cross section may be defined as a surface normal to the direction of current flow between the anode contact position and the cathode contact position.

The specimen may be bar shaped in a central region between the anode contact position and the cathode contact position. The central region may comprise at least half the distance (or at least 75% of the distance) from the anode contact position to the cathode contact position.

The specimen may have an irregular shape.

The specimen may comprise a ceramic material. The specimen may comprise Yttria-stabilized zirconia, or YSZ. The specimen may include 3YSZ, which is 3 mol % Yttria-stabilized zirconia, for example.

The core may be centred on the longitudinal axis and may include an area of the specimen around the longitudinal axis. The core may be a generally cylindrical area around the longitudinal axis, for example, having a diameter of 0.1× (or 0.2×, or 0.3×) the lateral width of the specimen. The core does not include the surface.

The anode contact position may be at a (non-zero) distance (or offset from) from the core and the cathode contact position may be at a (non-zero) distance (or offset from) from the core. At least one of the distances may be non-zero. For example, the anode contact may be positioned off the longitudinal axis of the specimen. The cathode contact may be positioned off the longitudinal axis of the specimen.

The contact positions of the anode and cathode electrodes may be closer to the perimeter of the specimen than to the longitudinal axis. Applying current via electrodes spaced from the longitudinal axis of the specimen may improve sintering closer to the perimeter of the specimen, whereas creating a hot path along the longitudinal axis from applying current via electrodes on the longitudinal axis results in a temperature gradient from the core to the surface.

The anode electrode may be a first anode electrode, and the method may comprise connecting a second anode electrode to the specimen at a second contact position. The cathode electrode may be a first cathode electrode, and the method may comprise connecting a second cathode electrode to the specimen at a second contact positions.

Including multiple anode and cathode electrodes and so applying current at multiple contact positions may improve homogeneity of sintering of the specimen.

The first anode electrode and the first cathode electrode may be arranged on a first side of a longitudinal axis of the specimen and the second anode electrode and the second cathode electrode may be arranged on a second, opposite, side of the longitudinal axis.

For example, each of the anode electrodes may be spaced from the longitudinal axis by an equal distance. Each anode electrode contact position may lie on an axis perpendicular to the longitudinal axis, equidistant from the longitudinal axis.

For example, each of the cathode electrodes may be spaced from the longitudinal axis by an equal distance. Each cathode electrode contact position may lie on axis perpendicular to the longitudinal axis, equidistant from the longitudinal axis.

The specimen may have a dead centre, on the longitudinal axis. The first anode electrode and the first cathode electrode contact positions may be equidistant from the dead centre of the specimen.

The second anode electrode and the second cathode electrode contact positions may be equidistant from the dead centre of the specimen.

If the electrode contact positions have symmetry on the specimen, this may improve homogeneity of sintering. This is not always the case—some specimens may have irregular shape and no symmetry.

The specimen may comprise holes at the contact positions for each electrode. The electrodes may be received at least partly inside the holes. An electrode may be connected at a hole inside the hole, for example through the hole.

Each hole may be positioned adjacent the surface of the specimen, between 1 mm and 2.5 mm from the surface of the specimen (but the spacing will depend on the size of the specimen). This may space the electrodes apart from the core. More generally, each hole may be spaced apart from the surface by between 2.5% and 20% of the width of the specimen.

The method may comprise applying a conducting material to the specimen in an anode contact region that includes the or each anode contact position and/or comprising applying a conducting material to the specimen in a cathode contact region that includes the or each cathode contact position.

The anode contact region may only include a hole to which the anode electrode is connected, or the anode contact region may have a greater area including the hole. Where there are first and second anode electrodes and first and second anode contact positions, the anode contact region may comprise both contact positions. Likewise, the cathode contact region may only include a hole to which the cathode electrode is connected, or the cathode contact region may have a greater area including the hole. Where there are first and second cathode electrodes and first and second cathode contact positions, the anode contact region may comprise both contact positions.

Where the specimen comprises more than one anode contact position and more than one cathode position, the method may comprise applying the conducting material in the anode contact region between the anode contact positions to intersect the anode contact positions and/or applying the conducting material in the cathode contact region between the cathode contact positions to intersect the cathode contact positions.

The conducting material may comprise a metal, for example a metal alloy. The conducting material may comprise platinum, for example.

The conducting material may be applied as a paste. The specimen may comprise a conducting material. The specimen may comprise a conducting paste, for example.

The method may comprise applying the conducting material to an interior surface of at least one of the holes.

The specimen may have a dog bone shape that is elongate and has two ends and a centre, having a greater width at the ends than at the centre, wherein the anode contact position and the cathode contact position are positioned in the wider parts of the dog bone shape.

For example, where there are first and second anode contact positions and first and second cathode contact positions, all of the contact positions may be in the wider parts of the dog bone shape.

The specimen may have a disc shape, wherein the anode electrode and/or cathode electrode has an annular shape. The disc shaped specimen may have pair of circular or substantially circular faces and an adjoining side (defining the thickness of the disc), and the annular electrode may have a diameter equal to or substantially equal to the diameter of the faces. The electrode contact position may be a ring, due to the annular shape. Connecting the electrode to the disc may include aligning the electrode with the disc at their edges.

The method may comprise: suspending the specimen by at least one of the anode electrode and/or cathode electrode in a furnace, connecting the electrodes to an electrical source, heating the furnace to preheat the specimen, and applying a voltage difference between the anode and the cathode to trigger flash sintering.

The method may further comprise stopping the supply of current to the specimen after at least a threshold amount of current has been supplied between the anode electrode and the cathode electrode for at least a threshold amount of time.

Another aspect of the present inventions provides a tool for performing the method of flash sintering of a specimen, the tool comprising:
a furnace;
a power source;
a first electrode and a second electrode, each connected to the power source and configured to apply current to a specimen to be flash sintered.

Another aspect of the present invention provides a part including sintered material produced by the method of flashing sintering of a specimen.

Another aspect of the present invention provides a method of modelling flash sintering of a specimen, comprising:
simulating current flow through the specimen resulting from an anode and a cathode in contact with the specimen;
simulating heat generated as a result of the current flow through the specimen and a heat distribution resulting from the heat generated and at least one heat loss boundary condition;
simulating sintering of the specimen in response to the heat distribution.

The modelling may comprise transient modelling.

The sintering of the specimen may be determined with reference to a density at the present time and the temperature at the present time.

Simulating the sintering may comprise varying the spatial distribution of at least one of:
i) density;
ii) thermal conductivity;
iii) electrical conductivity.

### DETAILED DESCRIPTION

Examples are shown in the figures, in which:

FIG. 1 shows a specimen including electrodes for causing current to flow;

FIG. 2 shows a specimen including more electrodes than in FIG. 1;

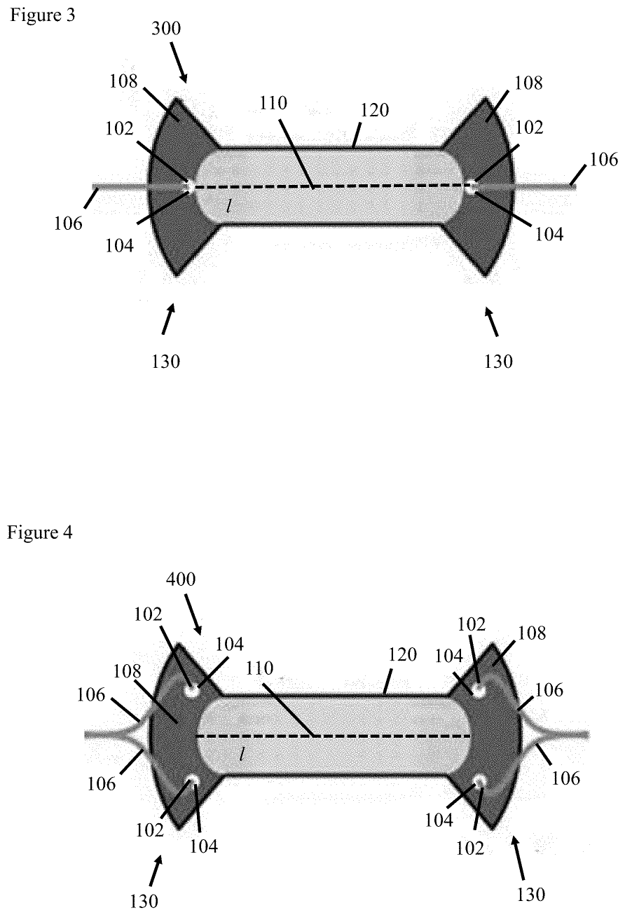

FIG. 3 shows a specimen having a different shape from the specimen in FIG. 1;

FIG. 4 shows a specimen having the shape of the specimen in FIG. 3 and an electrode configuration analogous to FIG. 2;

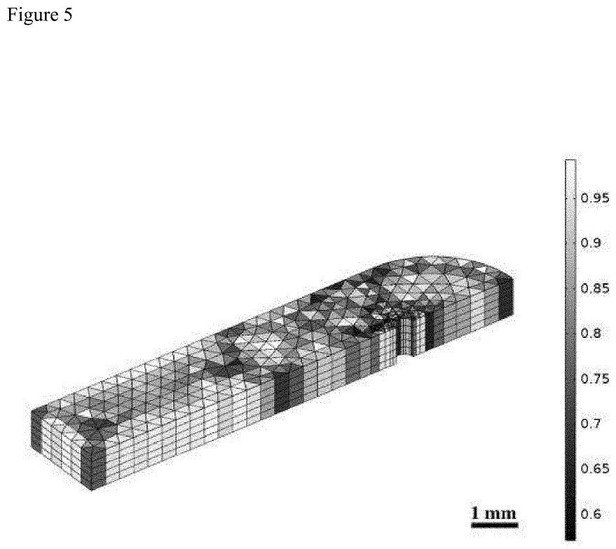

FIG. 5 shows a model of the specimen of FIG. 1 with symmetries and the grey-scale bar showing the mesh quality;

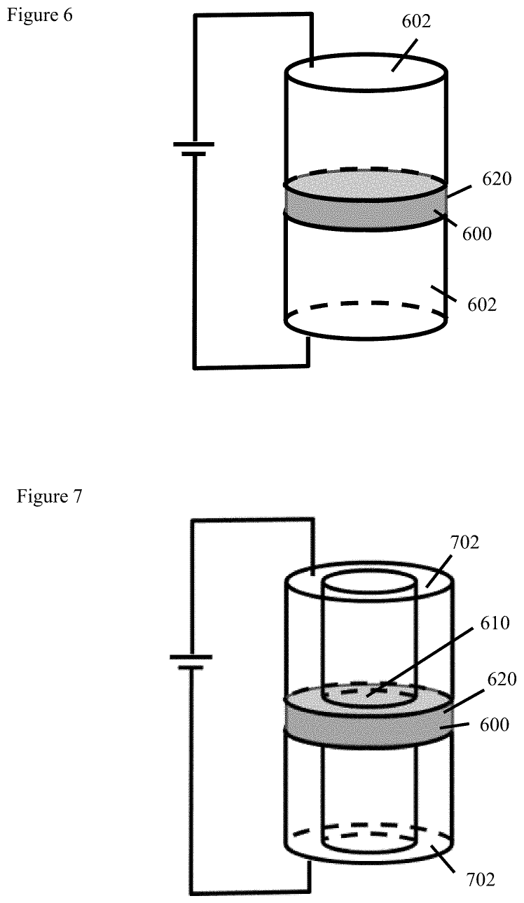

FIG. 6 shows a prior art approach to flash sintering a disc specimen;

FIG. 7 shows an alternative approach to flash sintering the disc specimen;

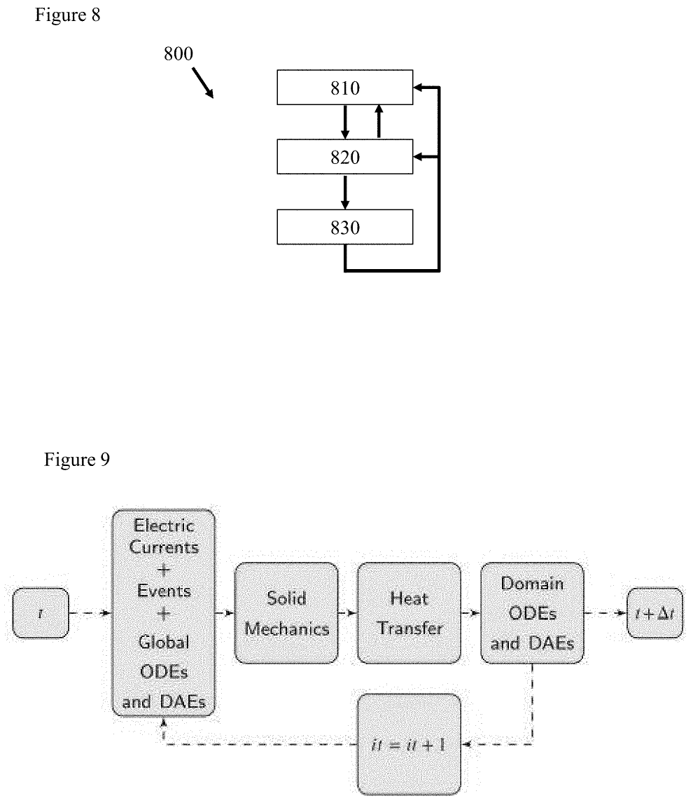

FIG. 8 shows a flowchart of a method of modelling a flash sintering process;

FIG. 9 shows a flowchart of part of a method of modelling flash sintering;

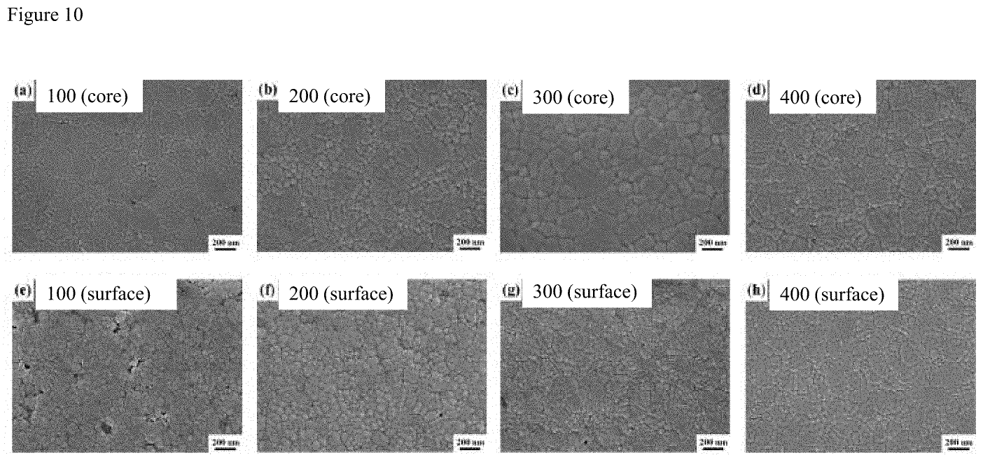

FIG. 10 shows surfaces and cores of four specimens;

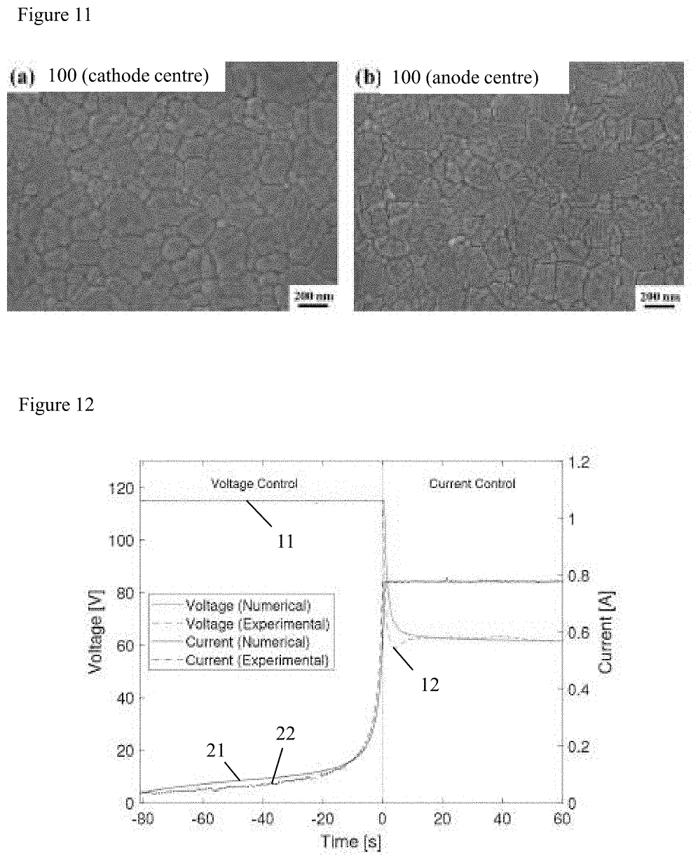

FIG. 11 shows the cathode centre and anode centre for one of the specimens;

FIG. 12 shows validation of voltage and current predictions in a plot;

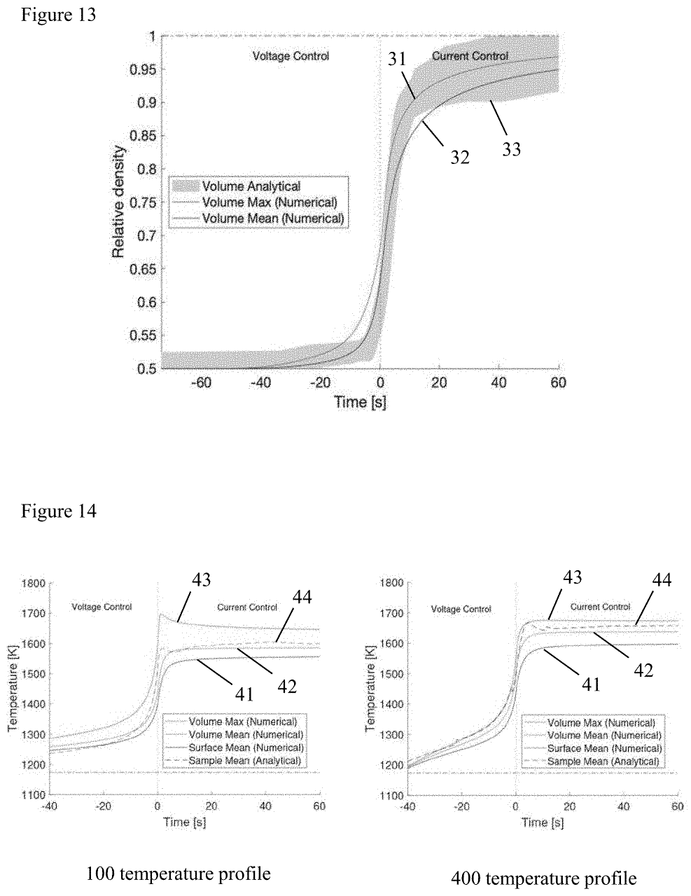

FIG. 13 shows a comparison of the density evaluated from experimental estimation against numerical prediction of the average and maximum density for one of the specimens (the specimen of FIG. 1);

FIG. 14 shows temperature profiles of the specimen of FIG. 1 and the specimen of FIG. 4;

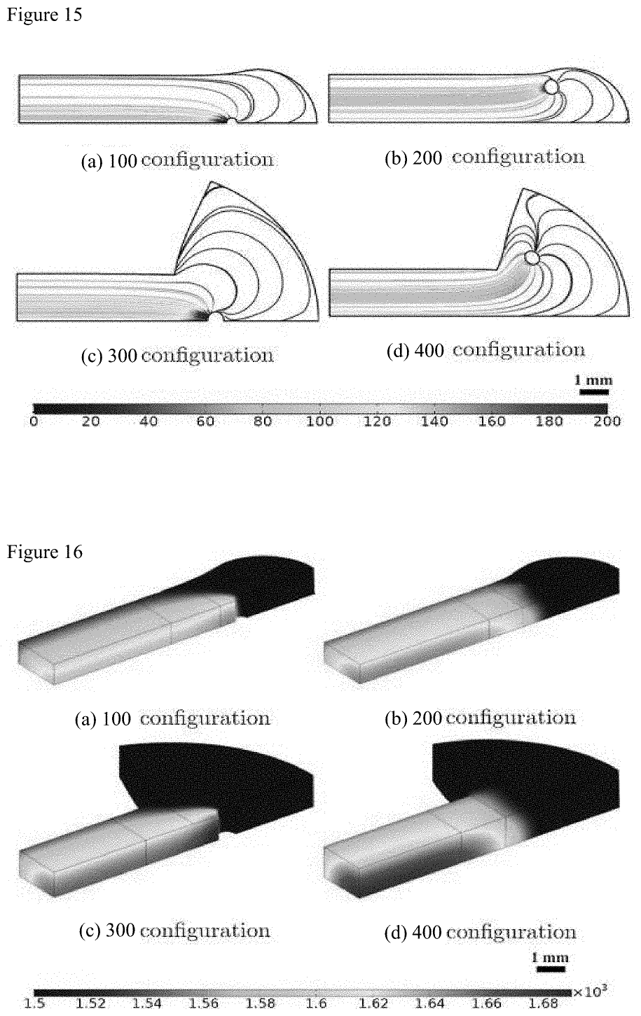

FIG. 15 shows current density streamlines for the specimens of FIGS. 1-4 at the end of FS analysed by a numerical model described herein;

FIG. 16 shows temperature distribution (in Kelvin) of the four samples of FIGS. 1-4 at the end of FS analysed by the numerical model;

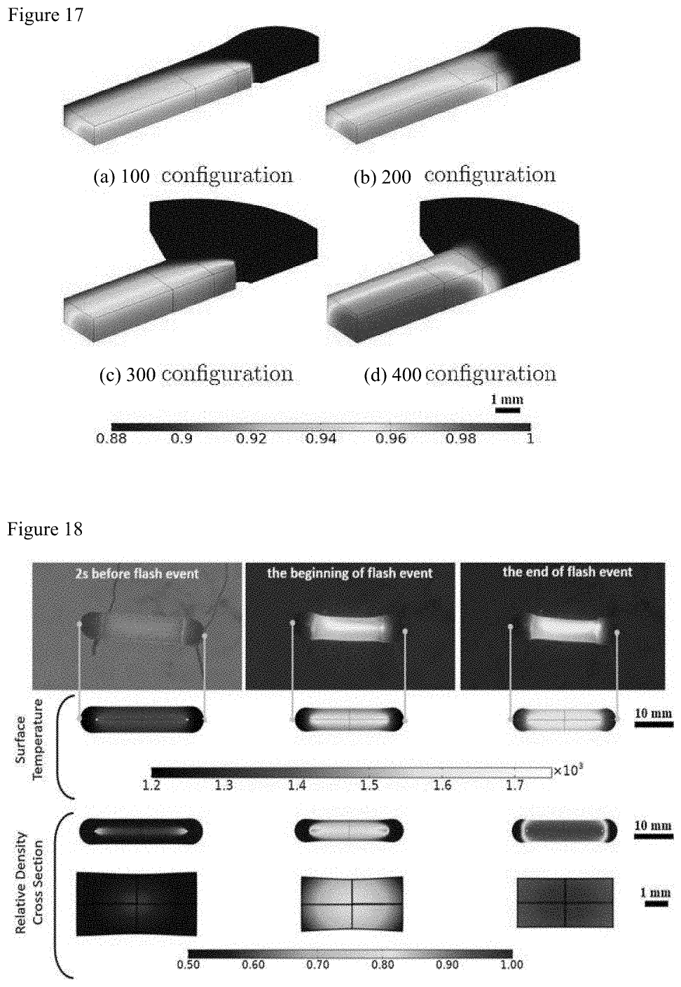

FIG. 17 shows relative density distribution in the four samples of FIGS. 1-4 at the end of FS analysed by the numerical method;

FIG. 18 shows snapshots of the specimen of FIG. 1 at 2 seconds before, at the beginning and at the end of a flash event, alongside the corresponding numerical predictions of surface temperature and relative density; and

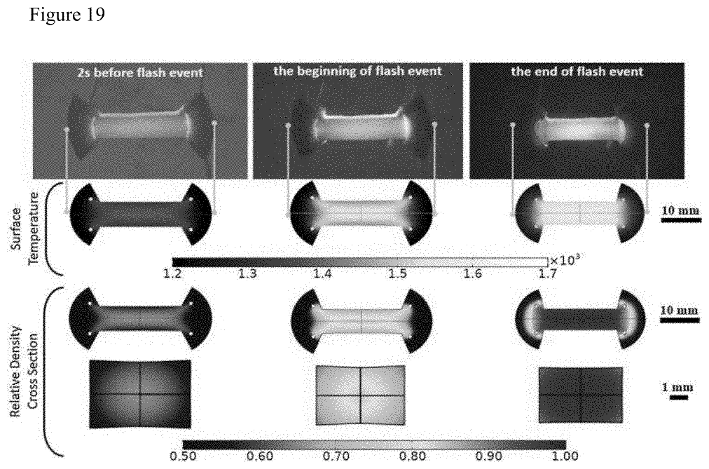

FIG. 19 shows snapshots of the specimen of FIG. 4 at 2 seconds before, at the beginning and at the end of a flash event, alongside the corresponding numerical predictions of surface temperature and relative density.

Embodiments of the present disclosure are described by way of example in more detail below.

To avoid a temperature gradient between the core of the specimen and its surface, the electrode configuration and/or the shape of the specimen in examples disclosed herein is different from that seen in typical FS processes. Other solutions have tried to eliminate thermal gradients by optimizing the external environment of samples during FS. However, if the current path can be controlled to avoid the local overheating of ceramic sample during FS, there is no need to adjust the external environment. The present invention improves the homogeneity of a flash sintered specimen by current path management. The preferential current path during FS is intentionally shifted from core to near-surface by judicious design of sample geometry and/or electrode configuration. The concentrated Joule heating near the sample surface can effectively balance heat loss from the surface (e.g. by radiation), creating a more uniform distribution of temperature inside the sample.

FIG. 1 shows a specimen 100 which has an electrode 102 connected to the specimen at each of two ends 130 of the specimen 100. These electrodes 102 are an anode electrode 102 and a cathode electrode 102 configured to pass current through the specimen 100.

Arranging the electrodes 102 as shown in FIG. 1 is a previously seen approach to flash sintering and has been tested against other approaches discussed herein to determine whether changing the location/number of electrodes 102 and/or changing the shape of the specimen 100 from a bar to another shape affects homogeneity of densification.

The specimen 100 of FIG. 1 has a bar shape. The specimen 100 may have a length of between 15 mm and 25 mm, for example 20 mm, and a width of between 3 mm and 10 mm, for example 5 mm. The specimen 100 may have a depth of between 1 mm and 2 mm, for example 1 mm, 1.5 mm or 2 mm. Components of any reasonable size or shape can be made. The problems of non-uniformity that the invention seeks to solve become more acute with increasing specimen size and complexity of shape.

The specimen 100 comprises a core 110 and a surface 120. As shown, the electrodes 102 are connected to the specimen 100 along a centre-line of the specimen 100, which is the longitudinal axis of the specimen 100, shown as line “l”. The core 110 may include a section of the centre-line l. The core 110 may be centred on the centre-line l and may extend between 1 mm and 2 mm from the centre-line l, for example. The core 110 may have a width of between 0.1× and 0.2× the width of the specimen 100, for example.

The surface 120 may be a side of the specimen 100 having a longitudinal axis parallel to the centre-line l (i.e. neither face of the bar shape at the ends 130 is the “surface” 120). In addition, the core 110 excludes the surface 120.

The electrodes 102 are connected to the specimen 100 at holes 104. In FIG. 1, the holes 104 are positioned on the centre-line l. The core 110 may include a section of the centre-line l through the middle of the specimen 100, between the holes 104.

The specimen 100 may have a depth perpendicular to its longitudinal axis/the centre-line l, the depth being along an axis into the page in FIG. 1. The holes 104 may extend into the specimen 100 in the direction of the perpendicular axis. The surface 120 may be an exterior surface (or face) of the specimen 100 other than the faces at the ends 130, defining the depth of the specimen 100 and running parallel to the depth of the holes 104.

Typically in flash sintering, heat dissipates most from the surface 120, with a temperature gradient in the specimen 100, causing increased densification at the core 110 compared with the surface 120.

The electrodes 102 may be platinum (Pt) electrodes 102, for example, and each electrode 102 may be connected to a wire 106 for connecting the electrode 102 to a power source. The wire 106 may be a platinum wire for example.

The holes 104 may be coated with a material 108 comprising an electrical conductor to assist with current flow. The coating may be paint or a paste or another material comprising an electrical conductor. An inner surface of the holes 104 may be so coated. As shown in FIG. 1, an area around a hole 104 may be coated with a conducting material 108. The material 108 may be a paste containing platinum, for example. The material 108 may be applied to an area including a hole 104. The material 108 may extend from the hole 104 to the closest end 130 of the specimen 100, for example. The material 108 may be applied at both ends 130 of the specimen 100, from an end 130 up to and including to the closest hole 104, and the core 110 may include the section of the centre-line l between the coated areas.

The area coated in the material 108 may be removed from the specimen 100 after sintering to leave the desired end product.

In one example of a method, four samples with different geometry and electrode configurations may be prepared by flash sintering, and the densification, microstructure, and flexural strength of flash sintered (FSed) ceramics may be systematically investigated. The specimen 100 of FIG. 1 wherein the specimen 100 includes 3YSZ may be one of the four samples.

FIGS. 2, 3 and 4 show three other example specimens. In the example method, the other three samples may take the shape and have the electrode geometries of the specimens shown in FIGS. 2, 3 and 4, providing alternative electrode configurations and/or shapes of specimen 100 from FIG. 1 for investigation.

FIG. 2 shows a specimen 200 having electrodes 102 connected thereto via holes 104 through the specimen 200. This specimen 200 may have any and all of the features of the specimen 100 of FIG. 1. In addition, the specimen 200 of FIG. 2 is shown to include additional holes 104 and electrodes 102. Instead of connecting the electrodes 102 on the centre-line l, as in FIG. 1, this example includes a pair of electrodes 102 connected towards each end 130 of the specimen 200, all of which are off-centre. In some examples, a direct current path along the core 110 or centre-line l is avoided in order to solve the problem of inhomogeneous sintering.

One of the pairs of electrodes 102—at one of the ends 130—may each be an anode electrode. The other pair may each be a cathode electrode.

In FIG. 2, each pair of electrodes 102 includes one electrode arranged one a first side of the centre-line l and one electrode arranged on a second, opposite, side of the centre-line l. Each pair may be arranged such that the electrodes 102 that are on the same side of the centre-line l are aligned with one another parallel to the centre-line l— as shown in FIG. 2.

At one end (the same end), the electrodes 102 or the holes 104 of the specimen 200 may be separated by around 2.5 mm or 3 mm, for example. Each hole 104 may have a span of around 2 mm to 2.5 mm; 2.3 mm, for example. Each hole 104 may be around 2.5 mm or less from the surface 120 of the specimen 200, for example between 1 mm and 2 mm from the surface 120 of the specimen 200.

The electrodes 102 or holes 104 at both ends may have the same separation between the pairs, and may be arranged at the same distances from the centre-line l. In this way, the specimen 200 may have three directional symmetry—along the centre-line l as well as perpendicular to the centre-line l in both perpendicular directions (in FIG. 2, into the page and vertically on the page). Keeping the specimen 200 symmetrical in terms of where the holes 104 are made may be beneficial when it comes to modelling flash sintering for the specimen 200. Symmetry of the electrodes 102 may be beneficial in terms of uniformity of heating.

FIG. 3 shows another version of the specimen 300, having a dog bone shape instead of a bar shape as shown in FIGS. 1 and 2. The specimen 300 may have any and all of the features of the specimen 100 of FIG. 1. Like the specimen 100 of FIG. 1, the specimen 300 of FIG. 3 includes a pair of holes 104 on the centre-line l. The dog bone shape may include faces at the ends 130 that are flat, or may have curved ends, or rounded ends.

FIG. 4 shows another version of the specimen 400, having a dog bone shape and including multiple electrodes 102 at each end 130 as in the specimen 200 of FIG. 2. The specimen 400 may have any and all of the features of the specimen 200. As shown, the holes 104 are arranged either side of the centre-line l at each end and are equidistant (or substantially equidistant) from the centre-line l. This symmetry may be beneficial in terms of uniformity of heating, as well as for modelling sintering as described below.

The holes 104 may be arranged between 2 mm and 3 mm from the centre-line l, for example 2.5 mm from the centre-line l. The holes 104 in the specimen 400 may be further from the centre-line l compared with the example of FIG. 2, as because of the dog bone shape there are parts of the specimen 400 towards its ends 130 that extend further from the centre-line l than in the bar shaped specimen 200. As shown in FIG. 4, the holes 104 may be positioned in the wider part of the dog bone shape—in this example, each hole 104 is positioned generally half way into the wider part of the dog bone shape (between the point where the specimen 400 begins to widen and the very end of the specimen 400). The holes 104 may be otherwise positioned in the wider part of the dog bone shape, for example between half way and two thirds of the way, or three quarters of the way, or further towards the very end of the specimen 400. Measured from the very end of the specimen 400 inwards towards the core 110, the holes 104 may be positioned between 1 mm and 5 mm from the very end of the specimen 400 for example.

Samples according to each version of the specimen 100, 200, 300, 400 of FIGS. 1-4 have been tested by experiment. Of all of them, the sample according to the version in FIG. 4 having both multiple electrodes 102 at each end, not along the centre-line l, and having the dog bone shape, produced the best results.

### Example Sintering Experiment

The starting material was a commercial 3YSZ powder (TZ-3Y-E, Tosoh, Japan), which has a mean particle size of 60 nm. The maximum density of 3YSZ ceramic sintered from the powder is 6.05×10³ kg/m³, as provided by supplier. To obtain bar-shape samples, the powder was uniaxially dry-pressed into bars in a steel die at ≈60 MPa, followed by cold isostatic pressing at 200 MPa. The as-received bars have a dimension of approximately 30 mm×6 mm×3 mm. To make dog bone samples, 3YSZ powder was added to distilled water to give a solid loading of 55 wt %, while 2 wt % (relative to the solid) of Dispex A40 was also added as a dispersant. The slurry was prepared with the assistance of ultrasonic dispersion, and then slip cast in dog bone shaped molds on a porous plaster substrate. Dog bone samples were also isostatically pressed at 200 MPa to ensure density uniformity. The as-received dog bone samples have a cross-section of approximately 6 mm×3 mm as for the bar specimens.

Both the bar and the dog bone samples were pre-heated in an alumina tube furnace in air at 600° C. for 1 h to remove the organic ingredients (binder or dispersant). A starting relative density of ≈50% was obtained in all the green bodies regardless of sample geometry. All the samples had 1 or 2 holes at both ends with a span of ≈23 mm from the anode to the cathode, for connections to the power supply.

Platinum paste was painted around the ends of specimens intersecting the holes to provide electrodes. The inner surfaces of the holes were also coated with Pt paste.

The green body of each sample was suspended by Pt wires in a box muffle furnace and connected to a commercial DC power source (EA-PS 9360-15, 1500 W, Elektro-Automatik, Viersen, Germany). The data were logged using Labview Software. The furnace was heated to 900° C. and held for 10 min to ensure a uniform temperature in the chamber. Subsequently, an initial electric field of 50 V/cm was applied to each sample to trigger flash sintering. The power supply was programmed to apply a constant voltage and then switched automatically to current control when a current density of 50 mA/mm² was reached. The power was turned off after the sample was flash sintered at the target current for 60 s. Videos of the whole processes were taken through a window in the furnace, and used as a validation for the numerical results.

The mean sample temperature during flash sintering is estimated using the non-equilibrium equation of the black-body radiation model:

$$Ts = {T}_{f} + {\int }_{0}^{t} \frac{V I - A σ ε ( {T}_{s}^{4} - {T}_{f}^{4} )}{{mC}_{p}} dt \qquad ( 1 )$$

where Tₛ is the sample temperature assuming a uniform temperature throughout the sample, T_{f} is the furnace temperature, which has a constant value of 1173 K, V is the voltage applied across the sample, I is the current, ε is the emissivity (taken as 0.7 in this work), σ is the Stefan-Boltzmann constant, A is the instantaneous surface area of the light-emitting part of the sample without Pt coating, m is the mass, and Cₚ is the specific heat (taken as 600 J/kg K) of the 3YSZ sample. It is worth noting that the instantaneous surface A is calculated from the videos.

After flash sintering, the sample ends covered with the Pt coating were cut off to obtain the central cuboid part. Bulk density (ρ) and open porosity (Vₒₚ) of the remaining samples were measured using the Archimedes displacement method. The density of the fully sintered 3YSZ (ρ_{f}) was taken as 6.05×10³ kg/m³ to estimate the relative density by the relation ρ*=ρ/ρ_{f}.

Cross-sections were cut from the midpoint of the length, polished to 1 μm finish using diamond abrasives, and then thermally etched at 1100° C. for 30 min. The microstructures of cross-sections (centre and short edge) were observed using scanning electron microscopy (SEM, Merlin-60-62, Zeiss). The mean grain size was estimated from SEM images using the mean linear intercept length. To analyze the flexural strength, bars of 19 mm×2.8 mm×2.1 mm were obtained by grinding and polishing the sample surfaces to 1 μm finish. The three-point bending strength of each sample was measured by a universal tester (Z030TE, Zwick, Germany) using a 15 mm span and a cross-head speed of 0.5 mm/min.

A total of 5 bars were tested from each specimen to acquire the mean and standard error of bending strength.

Four different specimens for the flash sintering of 3YSZ samples are compared herein. The combination of two shapes (straight and dog bone) and two electrode connections (one or two holes per side) allows the generation of four configurations that have noticeably different flash sintering behaviours, both in terms of final average density as well as of uniformity of densification within the cross section. Specifically, the presence of two holes proves to be extremely beneficial as it leads to an increase of the final density with respect to the same shape with a single hole—results are discussed below. The configuration with two holes shows also a significant reduction of the grain size gradient between the core and the surface of the specimen, leading to a much more uniform microstructure than the one obtained with the corresponding samples with a single hole.

The specimen shape and the aspect ratio of the cross-section also prove to influence the final density of the material, both in terms of mean value, as well as in terms of uniformity within the cross section. Specifically, the dog bone shaped specimens reached higher and more uniform density than the corresponding straight specimens with the same number of holes for the electrodes, and cross-section aspect ratios closer to 1 are also beneficial.

The combined effect of shape, aspect ratio and multiple electrodes lead the thick dog bone specimen with two electrode holes per side to reach the highest density of 99.7% and a flexural strength of 1501±15 MPa, and with the most uniform grain size distribution among the samples, which are similar in shape the specimens 100, 200, 300 and 400.

To explore the reasons behind the different behaviours, a numerical model of each of the specimens was built and is discussed below.

A constitutive model, able to accurately predict the electrical, thermal, and mechanical behaviour of the material has been developed, which is capable of simulating flash sintering. The model can be used to determine appropriate electrode position and specimen design for improved flash sintering, for example. The model has been used to simulate the sintering of the four different specimen configurations 100, 200, 300 and 400, for example. The numerical simulations allow for understanding how the shape and the number of electrode holes affect the current path, which in turn leads to different temperature distributions and densification patterns.

The simulations show how the dog bone shape, with its larger extremities, leads to a more uniform current density within the gauge section, which induces a more homogeneous densification.

The approach, based on the combination of experimental tests and numerical simulations allows the exploration of the effect of the different specimen configurations, to identify the best design among the ones considered, and to analyse the reasons behind the different sintering outcomes. Additionally, the comparison of experimental and numerical results also allows for identifying the limitations of the experimental setup, highlighting the difference between the real behaviour and the idealised configuration, thus helping further to improve the specimen design.

From the inventors' perspective, the proposed multiphysics numerical model of FS described below can be seen as a first attempt of including electrical, thermal, and mechanical physics and it can help in overcoming crucial obstacles for commercialization of the FS technique, such as the thermal gradients, by investigating different electrical excitation, number and arrangement of electrodes, and electrical control strategies.

As well as the four specimens 100, 200, 300 and 400, a fifth specimen 600 is discussed as the general principles of adjusting the geometry of electrodes to homogenise densification discussed herein can also be applied to disc specimen 600 by adapting the usual electrodes used.

Specimen 600— disc shaped specimen

FIG. 6 shows an approach for flash sintering a disc specimen 600 (having a disc shape) using electrodes 602 contacting the circular faces of the disc specimen 600. The same principal of adjusting the geometry of electrodes to homogenise densification as is seen in FIGS. 2 and 4 is shown in FIG. 7 in the context of a disc specimen 600, in which at least one tubular electrode 702 is employed.

Flash sintering of a disc specimen 600 may take place in a furnace at moderate temperature. As the specimen 600 is more resistive than the electrodes 602, heat is dissipated in it when current flows. By the usual methods, as shown in FIG. 6, some of the Joule heat is conducted to the electrodes 602 but it all ends up being lost to the outside, so the hottest point is in the centre of the disc sample 600 and the rest of it is cooler. The specimen 610 may have a core 610 including the dead centre of the disc specimen 600. The disc 600 may have a longitudinal axis through the dead centre of the disc 600 and the core 610 may include the parts of the disc 600 along the longitudinal axis. The core 610 may have a diameter of between 0.3× and 0.5× of the diameter of the disc 600, for example.

The specimen 600 may have a surface 620 defined as the depth of the disc between the two circular faces (i.e. the side of the disc sample 600 that is not connected to electrodes 602). Heat may dissipate from the surface 620. In consequence, the densification is non-uniform—the sintered material made from the disc sample 600 is more porous at the edge and the grain size is bigger in the middle. The localisation of the current may not be dead centre—instabilities can develop some distance away from the centre giving hot spots.

The tubular electrode 702 may be generally cylindrical, with a cut out in its centre such that the tubular electrode 702 is annular. The electrode 702 may have generally the same surface area as the disc specimen 600, such that arranging the electrode 702 on the surface 620 may align the solid parts of the electrode 702 with parts of the disc specimen 600 furthest from its core 610—i.e. near the perimeter area of the disc specimen 600 or near the surface 620 or closer to the surface 620 than to the core 610. With cylindrical electrodes the current flow and Joule heating is at the edge of the specimen 600. Therefore, the heating is concentrated near the place where most heat is lost, making the heating more uniform. The heating is concentrated near the place where most heat is lost, making the heating more uniform.

The annular electrode 702 may have an inner and outer diameter (the diameter of the cut out and diameter of the electrode 702 as a whole), which may be in the range 1 mm to 100 mm, for example.

FIG. 7 shows that both electrodes 702 are annular; however, the arrangement may work effectively if only one of the two electrodes 702 is annular. The other electrode 702 may alternatively be the same as one shown in FIG. 6—a solid cylinder 602 instead of an annular electrode 702.

In some embodiments, a highly conductive material may be applied to the specimen 600 to define an annular conductive region on either side. A point contact anode and a point contact cathode may be connected to the conductive material on either side of the specimen 600. Provided the conductivity of the highly conductive material is sufficiently high, this approach will achieve much the same results as contacting an annular electrode on the specimen

Modelling Flash Sintering

FIG. 8 shows a flowchart of a method 800 of modelling flash sintering a specimen. The method 800 includes the following steps:
(810)—simulating current flow through the specimen resulting from an anode and a cathode in contact with the specimen;
(820)—simulating heat generated as a result of the current flow through the specimen and a heat distribution resulting from the heat generated and at least one heat loss boundary condition;
(830)—simulating sintering of the specimen in response to the heat distribution.

Steps 810 and 820 may not necessarily be sequential as shown in this example. Electrical conductivity may be dependent on temperature so the current flow may be affected by heat generation in the sample. The heat capacity, electrical properties and thermal conductivity may be affected by sintering. The method may be iterative. For example, an iteration may be performed between steps 810 and 820 until the heat/temperature distribution has converged. The method may also iterate from step 830 back to step 810.

Modelling according to the method 800 may include transient modelling, which may include considering the effects of the current flow over time on the heat distribution within the specimen. The specimen may be any of the specimens 100, 200, 300, 400 described above, or the method may be applied to another specimen. Transient modelling may include observing changes to the heat distribution over a given time period. For example, the model may consider changes to heat distribution between a first time, which may be when the current is initially applied, to a second time in the future. The second time may be the time after applying current that the specimen is expected to be sintered in the conditions of the model, which may be 60 seconds for example.

As part of modelling, the sintering of the specimen may be determined with reference to a density at the present time and the temperature at the present time.

The modelling may further comprise varying the spatial distribution of one or more of the density of the specimen, or thermal conductivity, or electrical conductivity.

In an example, a numerical approach to model the entire sintering process was developed and used to simulate the experimental tests discussed above. For example, the numerical approach may be used to analyse specimens 100, 200, 300, 400 according to the four different configurations presented above. The size of the gauge sections, i.e. the part of the specimen between the power connection holes, of the four models created is summarised in Table 1:

TABLE 1
Gauge sections in mm of the four samples

| | width × thickness × length |
|---|---|
| Sample | (hole-to-hole) |
| 100 | 5.84 × 2.66 × 23 |
| 200 | 5.80 × 2.70 × 24 |
| 300 | 5.85 × 3.34 × 22 |
| 400 | 5.92 × 4.04 × 23 |

The model of the sintering process was implemented using the commercial software COMSOL Multiphysics® and includes specific modules already present in the software to model the thermal, electrical, and mechanical behaviour of the specimens. The densification of the material is, instead, reproduced by implementing differential equations linking multiple physics, allowing for the shrinking of the material.

Including the sample densification in numerical models of FS is a new approach that improves the numerical modelling.

The model may comprise pentahedral elements. The mesh may comprise a graded element size that is finer around the holes where the gradients are expected to be more significant, as presented in FIG. 5. The quality of the elements, expressed in terms of aspect ratio, is presented in the FIG. 5, and shows the absence of distorted elements that could affect the accuracy of the simulations. Additionally, to further improve the quality of the results, second order elements may be used for all the simulation modules (i.e. solving for each physics domain).

Given the symmetry of the specimens along three perpendicular planes, only one eighth of it is modelled, and symmetry boundary conditions are imposed to the mid-planes, thus reducing the computational cost of the simulations which is particularly advantageous since several physical processes are involved in the model. The use of symmetry implies that any physical quantity (temperature, density, etc.) does not depend on the different electric polarity of the voltage feed. Although experimental evidence reported in the literature shows that different temperature, and therefore microstructure, can be obtained near the anode and cathode of FSed specimens subjected to DC voltage, the electrochemical reduction phenomena responsible for this behaviour are ignored in the numerical formulation. This assumption is justified by the limited asymmetry expected in the sintering of the samples used for this work, which was proven by the post-mortem analysis of the samples presented in the results below.

Electrical boundary conditions (at first constant voltage and then constant current) were applied to the inner surface of the electrode holes, thus ignoring the presence of Pt paste on the ends of the specimen. Although it is known that the liberal application of Pt paste can reduce the thermal asymmetry between the anode and the cathode, since the resistance of the fired paste is much higher than that of the wire a local runaway effect is expected, which would heat up the volume around the hole and induce the current to enter the specimen mainly from the inner surface of the hole. This assumption is supported by the experimental observation that shows a heating hotspot in correspondence of the electrode connection and also by the fact the use of two electrodes rather than one gives a clear improvement to the sintering, which would not be the case if the paste were the dominant conduction path.

A set of semi-empirical relationships are introduced to model the variation during the sintering process of certain material properties, from the green body condition (indicated with the subscript g) to the fully sintered material (identified by the subscript f). For sake of conciseness and readability of the equations, the time dependence of the variables is implicit.

The material is modelled as a conductive medium with temperature (T) and density (φ dependent conductivity. The conductivity σ of the green body and of the fully sintered material are modelled with an Arrhenius law, and the conductivity of the material is assumed to be the weighted average, with respect to the density, of the values for green body and fully sintered material, i.e.:

$$σ = {σ}_{g} {e}^{- \frac{{Q}_{g}}{RT}} + ( {σ}_{f} {e}^{- \frac{{Q}_{f}}{RT}} - {σ}_{g} {e}^{- \frac{{Q}_{g}}{RT}} ) ( \frac{ρ - {ρ}_{g}}{{ρ}_{f} - {ρ}_{g}} ) \qquad ( 2 )$$

where σ is the conductivity, and Q is the activation energy. The values for the green body and the fully sintered material are derived from direct experimental measurement.

The thermal conductivity k of the material, instead, is assumed to vary only with the density, following the law:

$$k = {k}_{f} \frac{2 ρ}{3 {ρ}_{f} - ρ} \qquad ( 3 )$$

As for the electrical conductivity, the values of the thermal conductivity of the green body and the fully sintered material (reported in Table 2, below) have been measured directly from experiments.

TABLE 2
Values of green body and fully sintered material
properties used in the numerical models

| State of sample | ρ [kg/m³] | σ [S/m] | Q [kJ/mol] | k[W/mK] |
|---|---|---|---|---|
| Green body | 3.025 × 10³ | 6.77 × 10⁵ | 139 | 0.4 |
| Fully sintered | 6.05 × 10³ | 3.7 × 10⁴ | 96 | 2.5 |

Finally, the densification of the material is described with a partial differential equation linking the rate of change of the density with the temperature and instantaneous density:

$$\frac{1}{{ρ}_{*}} \frac{\partial {ρ}_{*}}{\partial t} = f ( {ρ}_{*} ) g ( T ) \qquad ( 4 )$$

where f(ρ.) and g(T) are functions of relative density and temperature, respectively, which are derived from the experimental results.

f(ρ.) and g(T) are usually in the form:

$$f ( {ρ}_{*} ) = {{ρ}_{*}^{k 1} ( \frac{1 - {ρ}_{*}}{\frac{{ρ}_{g}}{{ρ}_{f}} - {ρ}_{*}} )}^{k 2} \qquad ( 5 )$$

$$and$$

$$g ( T ) = {k}_{4} {T}^{k 3} {e}^{- \frac{{k}_{5}}{RT}} \qquad ( 6 )$$

where k1, k2, k3, are integer, possible negative, numbers, whereas k4 and k5 are real positive numbers.

Equations of the type of (5) and (6) are typically derived from physical knowledge of the sintering process or from experimental results. However, given the lack, at the present time, of a sufficient knowledge of the micro-scale flash sintering phenomenon, the constants in (5) and (6) are chosen empirically. The choice of (5) affects the choice of (6), and vice-versa. In the literature, for similar problems, optimization algorithms are often used for automatically constructing (5) and (6) to accurately fit the experimental results.

In this work, the linear-shrinkage measured from videos of the experiment is used to derive the left-hand-side of (4), and (5) and (6) are chosen accordingly. Several choices of (5) and (6) are possible. However, some choices of (5) may lead to unrealistic (6), e.g. non-monotonic functions. An optimisation algorithm has been developed to evaluate the best fit of (5) and (6) with the experimental data, as reported in Table 3 (below) for kh, with h=1, . . . , 5.

TABLE 3
Values chosen for kₕm with h = 1, . . . , 5

| k₁[—] | k₂[—] | k₃[—] | k₄[K/s] | k₁[kJ/mol] |
|---|---|---|---|---|
| 0 | 2 | −1 | 1.25 × 10¹⁵ | 290 |

Imposing the slight approximation that the mass of the specimen remains unchanged during the sintering process, the increase in density is translated into uniform isotropic shrinkage of the finite element by using the thermal strain multiphysics feature in the “Solid Mechanics” COMSOL module:

$${ε}_{t} = {( \frac{{ρ}_{g}}{ρ} )}^{1 / 3} - 1 \qquad ( 7 )$$

where εₜ is the linear thermal strain. The actual values of the relevant material properties for both the green body and the fully sintered material, derived from direct experimental measurements, are reported in Table 2. Density, conductivity, and activation energy are measured directly from the experiments, and the values of heat conductivity are extracted from K. W. Schlichting, N. P. Padture, P. G. Klemens, Thermal conductivity of dense and porous yttria-stabilized zirconia, J. Mater. Sci. 36 (12) (2001) 3003-3010.

Although the model is phenomenological, the temperature dependence of electrical conductivity and sintering have a physical basis. This allows the comparison of the activation energies for these processes with conventional measurements. The range of activation energies for electric conduction of 96-139 kJ/mol (Q in Table 2) is higher than the activation energy for ionic conductivity under low current density conditions of 77 kJ/mol. The discrepancy is most likely an artefact associated with the electrochemical reduction of the 3YSZ at the high current densities experienced during flash sintering, which is known to increase the conductivity by allowing electronic conduction. The activation energy for densification of 290 kJ/mol (k5 in Table 3) is significantly lower than the value of 485 kJ/mol reported for conventional sintering of the same powder. This suggests a difference in rate-controlling diffusion mechanism in flash sintering compared with conventional sintering.

Multiphysics Solver

The methodology developed to model the flash sintering integrates different modules included in the commercial software COMSOL Multiphysics® (but any multi-domain finite element software may be used). The “Electric Currents”, “Heat transfer”, and “Structural mechanics” modules are used to reproduce, respectively, the electrical, thermal, and mechanical behaviour of 3YSZ (the chosen sample material for this particular example) prior, during, and after the sintering process. Moreover, the multiphysics functionality of COMSOL Multiphysics® is used to link the different physical processes. Additionally, the “Event” and “Global ODEs and DAEs” modules are used to simulate the switch from voltage to current control, reproducing the electrical power supplied to the specimen. Finally, the “Domain ODEs and DAEs” module is used to model the change in density (and in volume) of the specimen, by implementing (4) as a user defined differential equation.

The material models and boundary conditions described in the previous section are implemented in the corresponding modules, and a segregated solver is set up to solve sequentially the different physical processes by means of the iterative scheme shown in FIG. 9. FIG. 9 shows the steps of: Electric Currents+Events+Global ODEs and DAEs, then Solid Mechanics, then Heat Transfer, then Domain ODEs and DAEs. At each internal step, an implicit problem is set up and the resulting system of equations is solved by using non-linear solvers and preconditioned iterative solution strategies.

The time stepping is adaptive and, in order to avoid the propagation of numerical issues, a small tolerance value of 10⁻⁶ is chosen for the stopping criterion. The minimum time step taken by the solver is ˜2×10⁻⁵ s, close to the switch from voltage to current control (i.e. close to the flash event), whereas the maximum time step is 0.5 s. Thanks to the adaptive time-stepping, each internal step required fewer than 10 iterations, depending on the distance in time from the flash. Analogously, the general multiphysics step also required fewer than 20 iterations for each time step. The whole simulation of each sample requires about 30 minutes. Computation timings are given with respect to a machine equipped with 6-core/24-thread processors (Xeon E5645 at 2.40 GHz) and 104 GB of RAM running Windows.

A Comparison of Experimental and Numerical (Simulation) Results

The outcomes of the experimental tests are analysed and compared against the numerical results, to identify the effect of the individual features on the property of the sintered material. First, the results of the FS experiments (with four samples having the properties of specimens 100, 200, 300 and 400) are compared to highlight the difference between the four specimen configurations, in terms of final density, microstructure topology, and mechanical properties of the material. The results of the numerical simulations are then analysed, and validated against the directly measured quantities during the flash sintering process as well as with the final properties of the material.

Experimental Results

The relative densities and open porosities of 3YSZ samples after flash sintering are listed in Table 4, below. It can be seen that increasing the number of power connection points and the replacement of bar-shape by dog-bone shape were effective in making the sample denser and less porous. Compared with specimen 100, the relative density was particularly improved by 7% in specimen 400. This proves for the first time that the densification efficiency of FS can be improved by simply acting on the sample geometry and electrode configuration.

TABLE 4
Steady state temperature (SST), density (DEN), open porosity (POR),
mean grain size core (GSC), mean grain size surface (GSS) and
flexural strength (FLEX) of the four FSed 3YSZ samples. Steady
state temperature is evaluated from Eq(1) and other results are
derived from experiments

| | SST | DEN | POR | GSC | GSS | FLEX |
|---|---|---|---|---|---|---|
| Sample | [K] | [%] | [%] | [nm] | [nm] | [MPa] |
| 100 | 1598 | 92.7 | 4.2 | 167 | 80 | 1203 ± 17 |
| 200 | 1643 | 96.0 | 1.9 | 148 | 92 | 1336 ± 19 |
| 300 | 1628 | 95.5 | 2.4 | 157 | 83 | 1258 ± 16 |
| 400 | 1658 | 99.7 | 0.2 | 137 | 111 | 1501 ± 15 |

The SEM micrographs in FIG. 10 show clearly the different micro-structural characteristics from the core and the surface of flash sintered samples.

FIG. 10 shows SEM images of the polished and thermally etched cross-sections from core (top row) and surface (bottom row) of 3YSZ samples having the properties of the four example specimens: (a, e) specimen 100, (b, f) specimen 200, (c, g) specimen 300, (d, h) specimen 400.

The central regions were dense in all samples and the mean grain size was in the order of specimen 100>specimen 300>specimen 200>specimen 400 as shown in FIG. (a-d). However, as estimated by the black-body radiation model, the sample temperature was in the order of specimen 400>specimen 200>specimen 300>specimen 100, which is reverse to the order of mean grain size.

Different extents of core/surface microstructural gradient can be found in all 3YSZ samples, which can be attributed to the heat loss at the sample surfaces during flash sintering. The surface of conventionally flashed sample (specimen 100) was found to have high porosity and small grains in FIG. 10(e). Increasing the number of power-connection holes [specimen 200, FIG. 10(f)], or the replacement of bar by dog bone geometry [specimen 300, FIG. 10(g)], was found to be effective in decreasing porosity and increasing grain size of the surface areas. When both of the two modifications were applied, a pore-free microstructure was successfully obtained at the surface of specimen 400 [FIG. 10(h)]. Moreover, the mean grain size of the surface (111 nm) was very close to that of the core region (137 nm) in specimen 400, indicating a fairly low extent of microstructure gradient. Therefore, it is demonstrated that the application of dog bone geometry, forked electrodes, and cross section aspect ratio effectively improved the density and microstructural homogeneity of 3YSZ samples.

The SEM images of the cross-section centers from the cathode and the anode of specimen 100 are shown in FIG. 11. There is no significant difference in the microstructures near the electrodes, with the mean grain sizes of cathodic and anodic centers, measured from FIGS. 11(a) and (b), equal to 168 nm and 165 nm, respectively.

Moreover, the microstructures at the electrodes are similar to that of the core region of specimen 100 in FIG. 10(a). Similar behaviour is observed also in the other 3YSZ samples (200, 300 and 400) and could mainly be attributed to two reasons: first, a generous coat of Pt paste was applied at the ends of 3YSZ samples to form high-quality electrodes, which mitigated the contact resistance at electrodes and the thermal asymmetry from cathode to anode. Second, a moderate current density of 50 mA/mm² and a short sintering time of 60 s were used to flash sinter the 3YSZ samples, which alleviated the electrochemical reduction at the cathode. Therefore, the asymmetry of FSed 3YSZ samples was not evident in this study. The systematic investigation on mitigating microstructure asymmetry from cathode to anode will be carried out in the future.

The three-point bending strengths of flash sintered 3YSZ samples are also shown in Table 4, and all the samples exhibit high strengths of ≥1200 MPa. It was evident that the increased number of power connection points and the replacement of bar-shape by dog bone-shape were beneficial for improving the strength of 3YSZ sample. Notably, specimen 400 possessed a very high strength of 1501±15 MPa, showing a significant increase of ≈25% compared to 1203±17 MPa for specimen 100. Furthermore, the standard deviations of strength from which the standard errors shown in Table 4 are derived were only ˜3%. This very high reliability of the strength corresponds to Weibull moduli ≥40. The smaller grain size in the core region, lower porosity at the surface, and improved core/surface microstructural homogeneity are considered to be responsible for the increase of the strength of 3YSZ ceramic. This result clearly demonstrated that uniform flash sintering could further enhance the mechanical properties of 3YSZ ceramic.

Numerical Modelling/Simulation Results

The experimentally measured dimensions of the specimens presented above were used to generate FE models of each of the four tests (of specimens 100, 200, 300 and 400).

To mimic the voltage source imposed during the experimental test, a variable electric potential was introduced between the surface of the hole and the symmetry plane perpendicular to the length of the specimen. To fully mimic the electrical load applied during the experimental tests, the difference of potential was kept constant during the voltage controlled regime, and then varied to impose constant current once the critical value of current for the specific sample was reached, which corresponds to an average current density of 50 mA/mm² in the green body.

To validate the numerical results, the evolution of current and difference of potential during the simulation have been compared against the experimental values directly measured during the sintering process showing excellent agreement. FIG. 12 shows the comparison between numerical and experimental measurements for the specimen 100. Similar curves, with comparable level of agreement were obtained for the other three samples (200, 300 and 400). Validation of voltage 11, 12 and current 21, 22 numerical predictions 12, 22 against experimental measurements 11, 21 during the FS of specimen 100 is shown. The critical instant for the transition from voltage to current control was defined as t=0 s.

Additionally, the densification predicted with the numerical models is compared against the evolution of the density evaluated from measuring the shrinkage of the specimens. The length of the top and bottom edges of the samples have been measured from the snapshots of videos of the experiments, with a frequency of 1 Hz. The density for each measurement has been calculated assuming uniform and isotropic deformation of the specimen as:

$$ρ = {{ρ}_{g} ( \frac{{L}_{g}}{L} )}^{3} \qquad ( 8 )$$

where ρ_{g} and L_{g} are the density and the length of the green body specimens, respectively.

The values of the densities evaluated using the measure of top and bottom edge of the specimen provide an estimate of the experimental scatter, which takes into account the asymmetry of the deformation observed during some tests. The rapid changes of camera exposure during the video due to the sudden variation of brightness during the test hinder the accuracy of the length measurements, which is taken into account by adding a 1% error to the value of L. The maximum and minimum values of the density evaluated for each video frame constitute the limits of the experimental scatter.

The comparison of the density evaluated numerically (solid lines) and experimentally (grey area) for specimen 100 is presented in FIG. 13. The line 31 represents the maximum value of the density, measured in the centre of the numerical model, at each time step. The line 32 represents the mean density evaluated in the volume between the holes, which in the experimental tests would not be covered by Pt paste. The curve of the numerically predicted mean density falls almost entirely within the scatter of experimental values represented by the gray area, showing excellent agreement between the simulations and the experiments. The numerical models seem to predict a more gradual evolution of the density than the experiments suggest, but the slight mismatch can be due to the already mentioned sudden change in brightness during the flash event, which affects the accuracy of the specimen length measurements at the beginning and the end of the flash. Similar results, and comparable level of agreement, were also obtained for specimens 200, 300 and 400.

FIG. 14 shows temperature (surface mean 41, volume mean 42, and volume maximum 43) evaluated numerically and compared against the surface mean temperature derived from experimental data 44 using Eq. (1), for specimen 100 (left) and specimen 400 (right). As can be seen, the numerical and analytical surface mean temperatures differ by about 50 K at the end of the transient. The simplistic assumption of single equivalent temperature leads to an overestimation of the temperature evaluated by (1). This results in Tₛ being greater than the actual average surface temperature of the sample. Approximations of the analytical approach (1) include the neglect of heat loss from the centre of the sample to the ends, beyond the electrodes, and to the wires supplying the current. Similar results, and comparable levels of agreement, were also obtained for specimens 200 and 300. The steady-state and the maximum temperatures predicted by the numerical model are reported in Table 5, below, alongside the surface temperature derived from experimental data using the black-body radiation model defined by (1). Additionally, the difference between the overall maximum temperature and the steady state mean temperature is reported in the table as a qualitative measure of the temperature homogeneity in the samples.

TABLE 5
Temperatures predicted by the numerical model bnoth
overall and at the steady state compared against the
sample mean temperature derived from experimental data
(T^{s}ₘₑₐₙ₋ₑₓₚ), using the black-body radiation
model Eq. (1), Results in K.

| — | 100 | 200 | 300 | 400 |
|---|---|---|---|---|
| T^{s}ₘₑₐₙ (steady state) | 1554 | 1568 | 1579 | 1596 |
| T^{v}ₘₐₓ (steady state) | 1645 | 1650 | 1658 | 1680 |
| T^{v}ₘₑₐₙ (steady state) | 1585 | 1608 | 1615 | 1637 |
| T^{v}ₘₐₓ₋ₜ (overall) | 1696 | 1657 | 1670 | 1681 |
| T^{v}ₘₐₓ₋ₜ − T^{v}ₘₑₐₙ | 111 | 49 | 55 | 44 |
| T^{s}ₘₑₐₙ₋ₑₓₚ (steady state) | 1598 | 1643 | 1628 | 1658 |

TABLE 6
Comparison of experimentally mesasured and numerically
predicted relative density of four specimens.

| — | 100 | 200 | 300 | 400 |
|---|---|---|---|---|
| Experimental | 92.7% | 96.0% | 95.5% | 99.7% |
| Numerical | 93.5% | 95.6% | 95.1% | 97.7% |
| Error | 0.8% | 0.4% | 0.5% | 1.9% |

TABLE 7
Fraction of the gauge volume with relative density higher than
95% for four numerial models. The gauge volume was defined as
the part of the same between the drilled holes at the ends.

| — | 100 | 200 | 300 | 400 |
|---|---|---|---|---|
| Volume fraction | 40% | 65% | 60% | 85% |

Table 6, above, shows the final average densities for the four samples predicted by the numerical model and compared with the experimental values. As can be seen, the agreement is quite good, with the difference well below 1% for the samples 100, 200, and 300, and less than 2% for the sample 400.

Finally, Table 7, above, shows the percent of the gauge section volume that has reached a high level of densification (p*≥95%) for the four samples. The gauge volume is defined as the part of the sample between the drilled holes at the ends. The results further prove the efficacy of the combination of forked electrodes with the dog bone shape on the densification of 3YSZ sample.

It is worth noting that the higher mismatch observed for the specimen 400 is due to the simplistic nature of the equation use to define f(p*) in Eq. (5), which does not include the effect of the stress gradients due to different sintering level. As the inner part of the specimen starts to sinter, the cold parts on the outside experience a compressive stress state, which should help the surface region to densify, which might be one reason why the experimental densities are slightly higher.

Modelling of traditional sintering often adopts piece-wise defined functions for f(p*), with different sets of parameters for different density ranges. In particular, numerical models of traditional sintering impose different behaviour of f(p*) for p*>90%, allowing for higher densification rate and density values than (5). However, given the limited knowledge of the micromechanical behaviour of 3YSZ during flash sintering, in this work a single set of parameters is adopted for all the densities, thus avoiding the introduction of artificial adjustments that cannot be reasonably justified.

The validations presented show the high level of accuracy of the numerical simulations, which are demonstrably able to reproduce the electrical response of the material during the sintering process as well as the densification process. This provides the confidence of using the numerical simulations to analyse the behaviour of the inner part of the specimen, and to explore the evolution of parameters within the whole volume, which would be extremely challenging to directly measure during the experimental test.

In particular, the numerical predictions of the distribution of current density, temperature, and density within the whole specimen volume are used to explain the possible reasons for the different behaviour of the four configurations 100, 200, 300 and 400.

Analysis

The experimental results demonstrate that the uniformity of flash sintering can be effectively improved by a rational design of the sample geometry and electrode configuration.

From the experimental results summarised in Table 4, the four configurations analysed, having the properties of example specimens 100, 200, 300, 400, lead to very different grain size distributions in the specimens, both in terms of absolute value and gradient between the core and the outer surface of the samples. Specifically, specimen 100 shows the highest grain size in the core, with the smallest grain size on the outer surface, which is compatible with the models that show that specimen 100 exhibits the highest temperature peak along the centreline at the flash (visible in FIG. 14(a)) combined with a steep temperature gradient towards the outer surface. A similar pattern is shown in the sample 300, as the presence of the single power connection point at each end focuses the current density (and therefore the temperature) along the centreline of the specimen, although the combination of dog bone shape and different cross-sectional dimensions reduces slightly the gradient between the core and the surface of the specimen. It is worth noting that the uniformity of the temperature distribution predicted by the numerical model (see FIG. 14 and Table 5) can be ranked as 400>200>300>100 which is coherent with the uniformity of the grain size distribution measured in the four samples (see Table 4).

The absence of a temperature peak at the flash in specimens 200 and 400, due to a more uniform current density within the gauge section, leads to a more uniform grain size distribution. The dog bone sample shows again a positive effect on the homogeneity of the microstructure, as a combination of thicker sample and large extremities with more widely separated power connections.

The use of numerical models allows monitoring the evolution of material parameters within the volume, linking the different final properties of the material to specific features of the specimen design. By analysing the current density in the four configurations, for example, it was possible to observe how the same electric potential generates very different current paths, as graphically shown by the current density isosurfaces presented in FIG. 15. The distribution of current density streamlines in the four models at the end of the sintering is significantly influenced by the design of the specimen. The use of two power connection points per side in the configurations 200 and 400 produces a wider and more uniform current density across the gauge section, contrary to what happens in the specimens 100 and 300, in which the position of the electrode on the plane of symmetry induces the current to flow along the region close to the central axis of the structure. Additionally, the presence of the large extremities and thicker cross section in the dog bone samples contributes to making the current density within the gauge section more uniform than in the corresponding straight configuration. To decouple the effect of the dog bone shape from the specimen thickness, numerical simulations of the 300 and 400 designs with the same dimensions as 100 and 200, respectively, were performed. The simulations showed that the aspect ratio of the cross section plays an important role in the uniformity of the current density (and consequently temperature and density) for all the specimens, with the homogeneity improving as the aspect ratio approaches 1. The large extremities, instead provide a minor effect on the current path for the specimen 300, leading to a slightly more uniform current distribution in the cross section. For the specimen 400 the effect of the large extremities is significant, as it allows the spacing of the electrodes to be larger than the actual cross section.

Following a similar pattern as the density of current, the temperature distribution in the gauge section is more uniform in the dog bone samples, as shown in FIG. 16. As a combination of all the effects described, the current density is mostly concentrated in the center for the sample 100, shifting slightly towards the edge in the sample 300.

Similar behaviour can be observed in the configurations 200 and 400, in this case enhanced by the increased distance between the power connection holes and the centreline of sample 400.

The different current density distributions lead to different temperature distributions, which in turn affect the densification process of the specimen, as shown in FIGS. 16 and 17, respectively.

The figure shows that also the number of holes for the electrodes is extremely significant, as the presence of two holes, away from the longitudinal axis of the specimen, provides a more uniform Joule heating in the gauge section, and consequently a more homogeneous temperature distribution in the cross section, than the configuration with only one hole per side. Increasing the number of holes has also the effect of reducing the current density close to the electrodes, thus lowering the temperature on the hole predicted by the numerical models. The reduction of the current density concentration close to electrodes also alleviates the adverse effect of the contact resistance between the electrode and the specimen, which is suspected to be one of the main sources of uncertainty in the experimental results. Given its unpredictable nature, the contact resistance was not considered in the numerical models, however the relatively good agreement between the experimental and numerical results indicates that the presence of the Pt paste reduced the overall influence of the contact resistance on the sintering process.

The uniformity of density predicted by the numerical models is in agreement with the experimental observations of grain size distribution in the cross sections presented in FIG. 10. As a consequence of the higher densification and more homogeneous grain size distribution, the flexural strength of 3YSZ ceramic was greatly increased from 1203±17 MPa for the bar specimen with one electrode hole per end (specimen 100) to 1501±MPa for the dog bone specimen with two holes at each end (specimen 400), as presented in Table 4.

The evolution of the temperature and density across the flash event for specimens 100 and 400 are graphically summarised in FIGS. 18 and 19. In the graphical summary three snapshots of the specimen during the experimental test—before, during, and after the flash event—are compared against the contour plots of temperature (top row) and relative density (bottom rows) predicted numerically at the same times.

Additionally, the vertical grey lines show visually the good agreement in the prediction of the specimen length during the sintering process described by FIG. 13. The visual comparison of the experimental behaviour against the numerical prediction of the specimens offers the possibility to analyse local behaviours.

Besides the already discussed temperature and densification localisation along the centre-line, other localised behaviours can be observed in the pictures of the experimental test, such as the slight bending of the specimen during the flash event and the localised temperature peaks around the electrodes. These features are due to the non-ideal nature of the contact between the electrode and the material. The non-uniform contact between the inner surface of the hole and the specimen leads to a slight bending of the specimen across the flash event, as the portion of specimen between the actual contact points sinters faster than the rest of the volume. Additionally, the contact resistance between the electrode and the specimen induces localised heating of the material which leads to the bright temperature peaks visible in the experimental test. Neither of these phenomena are reproduced by the numerical model, as the electrodes are imposed to be in contact with the inner surface of the hole and without any contact resistance. The good agreement between the experimental and numerical results suggests that the contact imperfections have little influence on the overall flash sintering process. Nonetheless, the outcome of this work will help designing improved configurations of flash sintering tests, with limited contact effects, in the future.

FIG. 19 shows a similar comparison between photos of the sample before, during, and after the flash event and the corresponding contour plot of temperature and density predicted by the numerical model for the specimen 400. As for the specimen 100, the prediction of the specimen length across the flash event is quite accurate, as the qualitative temperature pattern. The localised phenomena observed in the specimen 100, due to non-ideal nature of the contacts, are very limited in the specimen 400 configuration, as the presence of two electrode holes per side, combined with the large extremities and the higher thickness of the specimen, reduce the contact resistance and limits the asymmetry of the sintering process.

Although specific examples have been described, these are not intended to limit the scope of the invention, which should be determined with reference to the accompanying claims.

1. A method of performing a flash sintering of a specimen, the method comprising:
connecting an anode electrode to a specimen at an anode contact and connecting a cathode electrode to the specimen at a cathode contact;
flowing current through the specimen from the anode electrode to the cathode electrode to heat the specimen by Joule heating and thereby sinter it;
wherein at least one of the anode contact and the cathode contact is configured to reduce a temperature gradient between a core in a central region of the specimen and a surface of the specimen.

2. The method of claim 1, wherein an anode contact position and/or a cathode contact position is offset from a centre-line or longitudinal axis of the specimen.

3. The method of claim 1, wherein contact positions of the anode and cathode electrodes are closer to a perimeter of the specimen than to a longitudinal axis of the specimen.

4. The method of claim 1, wherein the anode electrode is a first anode electrode, the method comprising connecting a second anode electrode to the specimen at a second contact position, and wherein the cathode electrode is a first cathode electrode, the method comprising connecting a second cathode electrode to the specimen at a second contact position, wherein the first anode electrode and the first cathode electrode are arranged on a first side of a longitudinal axis of the specimen and wherein the second anode electrode and the second cathode electrode are arranged on a second, opposite, side of the longitudinal axis.

5. (canceled)

6. The method of claim 1, wherein the specimen comprises holes at the contact positions for each electrode, wherein each hole is positioned between 1 mm and 2.5 mm from the surface of the specimen, wherein the electrodes are received at least partly inside the holes.

7-8. (canceled)

9. The method of claim 6, comprising applying a conducting material to the specimen in an anode contact region that includes the or each anode contact position and/or comprising applying a conducting material to the specimen in a cathode contact region that includes the or each cathode contact position.

10. The method of claim 9, wherein the conducting material comprises platinum.

11. The method of claim 9, wherein the conducting material is applied as a paste.

12. The method of claim 9, comprising applying the conducting material to an interior surface of at least one of the holes.

13. The method of claim 9, wherein the specimen comprises more than one anode contact position and more than one cathode position, the method comprising applying the conducting material in the anode contact region between the anode contact positions to intersect the anode contact positions and/or applying the conducting material in the cathode contact region between the cathode contact positions to intersect the cathode contact positions.

14. The method of claim 1, wherein the specimen has dog bone shape that is elongate and has two ends and a centre, having a greater width at the ends than at the centre, wherein the anode contact position and the cathode contact position are positioned in the wider parts of the dog bone shape.

15. The method of claim 1, wherein the specimen has a disc shape, wherein the anode electrode and/or cathode electrode has an annular shape.

16. The method of claim 1, wherein the specimen comprises an irregular shape.

17. The method of claim 1, comprising:
suspending the specimen by at least one of the anode electrode and/or cathode electrode in a furnace,
connecting the electrodes to an electrical source,
heating the furnace to preheat the specimen, and
applying a voltage difference between the anode and the cathode to trigger flash sintering, and
stopping the supply of current to the specimen after at least a threshold amount of current has been supplied between the anode electrode and the cathode electrode for at least a threshold amount of time.

18-19. (canceled)

20. A part including sintered material produced by the method of flash sintering of a specimen according to claim 1.

21. A method of modelling flash sintering of a specimen, comprising:
simulating current flow through the specimen resulting from an anode and a cathode in contact with the specimen;
simulating heat generated as a result of the current flow through the specimen and a heat distribution resulting from the heat generated and at least one heat loss boundary condition;
simulating sintering of the specimen in response to the heat distribution.

22. The method of claim 21 wherein the modelling comprises transient modelling.

23. The method of claim 21 wherein the sintering of the specimen is determined with reference to a density at the present time and the temperature at the present time.

24. The method of claim 21 wherein simulating the sintering comprises varying the spatial distribution of:
i) density of the specimen;
ii) thermal conductivity;
iii) electrical conductivity.

25. The method of claim 1, comprising:
modelling flash sintering by:
simulating current flow through the specimen resulting from an anode and a cathode in contact with the specimen;
simulating heat generated as a result of the current flow through the specimen and a heat distribution resulting from the heat generated and at least one heat loss boundary condition;
simulating sintering of the specimen in response to the heat distribution,
wherein the configuration of the anode contact and/or the cathode contact to reduce the temperature gradient is determined in response to the results of the modelling.
